(19) United States
(12) Patent Application Publication
(10) Pub. No.: US 2017/0318799 A1
(43) Pub. Date: Nov. 9, 2017

(54) Ladder tree stand dolly and method

(71) Applicant: Leslie Paul Stilwell, Ridgway, PA (US)

(72) Inventor: Leslie Paul Stilwell, Ridgway, PA (US)

(21) Appl. No.: 15/731,230

(22) Filed: May 5, 2017

Related U.S. Application Data
(60) Provisional application No. 62/391,640, filed on May 6, 2016.

(51) Int. Cl. A01M 31/00; E06C 7/16; B62B 1/20; E06C 7/50

(52) U.S. Cl. CPC A01M 31/00; E06C 7/505; A01M 31/006; B62B 1/20; E06C 7/16

(57) ABSTRACT

Apparatus and method for transporting a section of a ladder tree stand or a stack of ladder tree stand sections and for transporting a harvested big game animal. The apparatus consists of a frame, a single wheel, an axle and a clamp. The axle is attached to the frame and the wheel is mounted on the axle. The clamp is used for clamping the frame to a ladder tree stand section or sections so that a hunter can transport the ladder tree stand section or sections by pushing or pulling the ladder tree stand section or sections on the wheel of the frame.

This application claims priority to U.S. Provisional Patent Application Ser. No. 62/391,640 filed May 6, 2016. The instant invention relates to apparatus and methods for use by a hunter to transport sections of a ladder tree stand into and out of a wooded area. Ladder tree stands consist of a number of ladder sections, one of which ladder sections comprises a seat for the hunter. In use, the hunter transports the sections into a wooded area and erects the ladder tree stand by strapping the assembled sections to a tree so that the hunter can climb the ladder sections to hunt from an elevated seated position. Many hunting areas prohibit the transport of a ladder tree stand by motorized vehicle. In such hunting areas, a number of trips are needed to carry the individual ladder sections to a hunting location.

### BACKGROUND OF THE INVENTION

A number of prior art discoveries have been made in an attempt to counter the difficulty of transporting ladder tree stand sections to a hunting location. For example, U.S. Pat. No. 5,064,020 discloses a ladder tree stand, the lower section of which comprises an axle onto which wheels can be mounted to either side of the lower section to convert the section into a hand cart. Similarly, U.S. Pat. No. 5,105,908 and U.S. Pat. No. 5,566,780 disclose a device to be inserted into one of the sections of a ladder tree stand, the device comprising a pair of wheels. U.S. Pat. No. 7,168,729 discloses a game cart/tree stand system comprising a bracket and a of a pair of wheels. A remaining problem with these advances in the art is the fact that the wheels used increase the width needed to negotiate a path through a wooded hunting location. In addition although most prior art systems can be used for transporting a harvested big game animal, it usually takes two persons to heft such an animal onto such a wheeled system. It would be an advance in this art if an apparatus and method were discovered that provided a narrower assembly and which allowed easier loading of a harvested big game animal for transport from a hunting location.

### SUMMARY OF THE INVENTION

The instant invention is an important advance in the art of ladder tree stand systems that can be converted into a game cart. The apparatus and method of the instant invention provides a narrower assembly and allows easier loading of a harvested big game animal for transport from a hunting location. This application claims priority to U.S. Provisional Patent Application Ser. No. 62/391,640 filed May 6, 2016 herein fully incorporated by reference.

More specifically, in one embodiment, the instant invention is apparatus for transporting sections of a ladder tree stand comprising: a frame, a single wheel, an axle and a first clamp, the axle attached to the frame, the wheel mounted on the axle, the clamp for clamping the frame to a ladder tree stand section so that a hunter can transport the ladder tree stand section by pushing or pulling the ladder tree stand section on the wheel of the frame. In another embodiment the instant invention is a method for transporting sections of a ladder tree stand, comprising: (a) clamping the apparatus of the instant invention to a ladder tree stand section; and (b) pushing or pulling the ladder tree stand section on the single wheel of the apparatus. In yet another embodiment, the instant invention is a method for transporting a harvested big game animal, comprising: (a) clamping the apparatus of the instant invention to a ladder tree stand section; (b) lying the ladder tree stand section on the ground beside a harvested big game animal so that the wheel is on the ground and the side of the ladder tree stand section is on the ground beside the harvested big game animal; (c) rolling the harvested big game animal onto the ladder tree stand section; (d) rotating the ladder tree stand section so that the harvested big game animal is above the wheel on the ladder tree stand section; and (c) pushing or pulling the ladder tree stand section on the single wheel of the frame to transport the harvested big game animal.

### BRIEF DESCRIPTION OF THE DRAWINGS

FIG. 1 is a drawing depicting an assembled ladder tree stand strapped to a tree, the stand comprised of an upper section that includes a seat and handrail, a central section and a lower section;

FIG. 2 is side view of the ladder tree stand sections shown in FIG. 1 disassembled and stacked on top of each other, the sections being transported by a hunter on a highly preferred apparatus of the instant invention which apparatus is shown strapped to the sections by a ratchet strap;

FIG. 3 is a front view of the front of the sections, strap and apparatus of FIG. 2;

FIG. 4 is a side view of the apparatus of FIGS. 1-3;

FIG. 5 is a top view of the apparatus of FIGS. 1-3;

FIG. 6 is a bottom view of the apparatus of FIGS. 1-3; and

FIG. 7 depicts the loading of a harvested big game animal onto the assembly shown in FIG. 3, the assembly tipped on the ground so that the animal can be rolled onto the assembly so that the assembly can be righted so that the harvested big game animal is above the wheel of the assembly so that the animal can be transported from a hunting location.

### DETAILED DESCRIPTION OF THE INVENTION

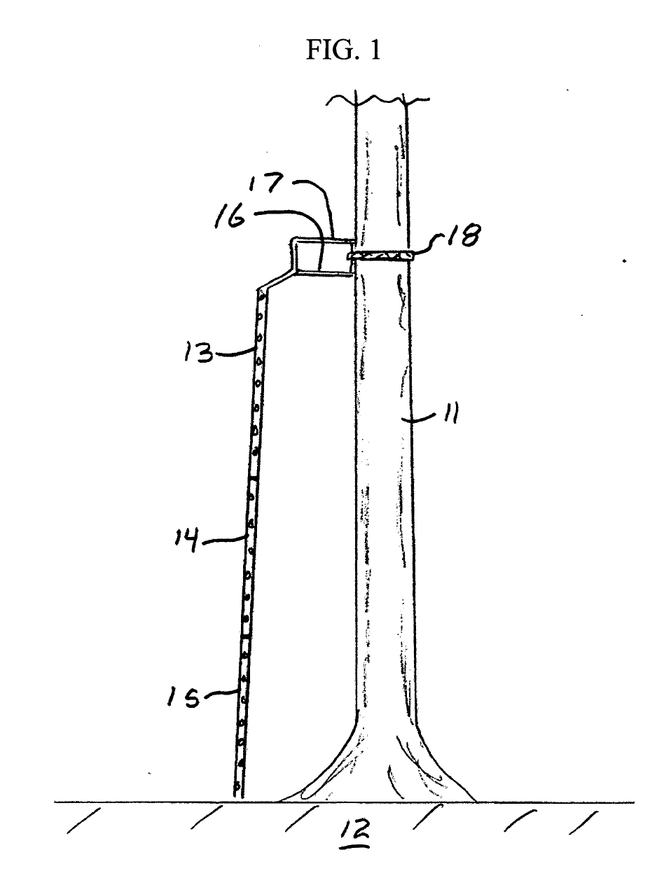

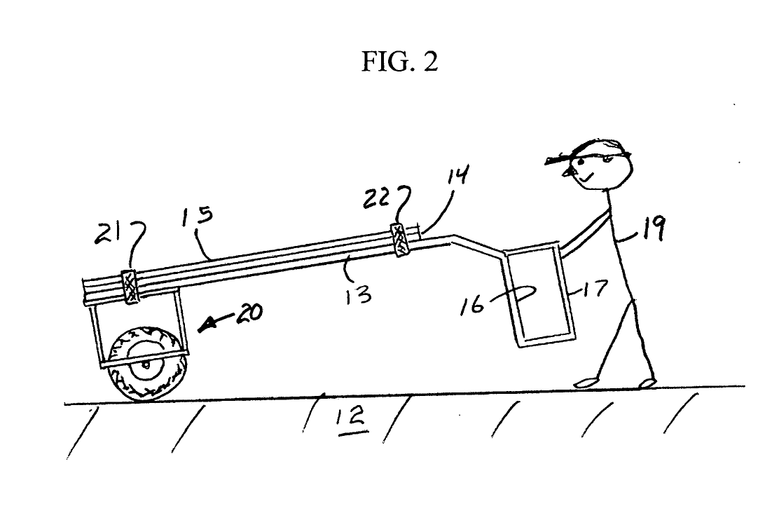

Referring now to FIG. 1, therein is shown is a drawing depicting an assembled ladder tree stand strapped to tree 11 by strap 18, the stand comprised of upper section 13 that includes seat 16 and handrail 17. Upper section 13 is attached to mid-section 14. Mid-section 14 is attached to lower section 15 resting on ground 12. Referring now to FIG. 2, therein is shown a side view of the ladder tree stand sections 13, 14 and 15 shown in FIG. 1 disassembled and stacked on top of each other. Sections 13, 14 and 15 are being transported by hunter 19 on a highly preferred apparatus 20 of the instant invention which apparatus 20 is shown strapped to sections 13, 14 and 15 by ratchet strap 21. Ratchet strap 22 is optional in the instant invention.

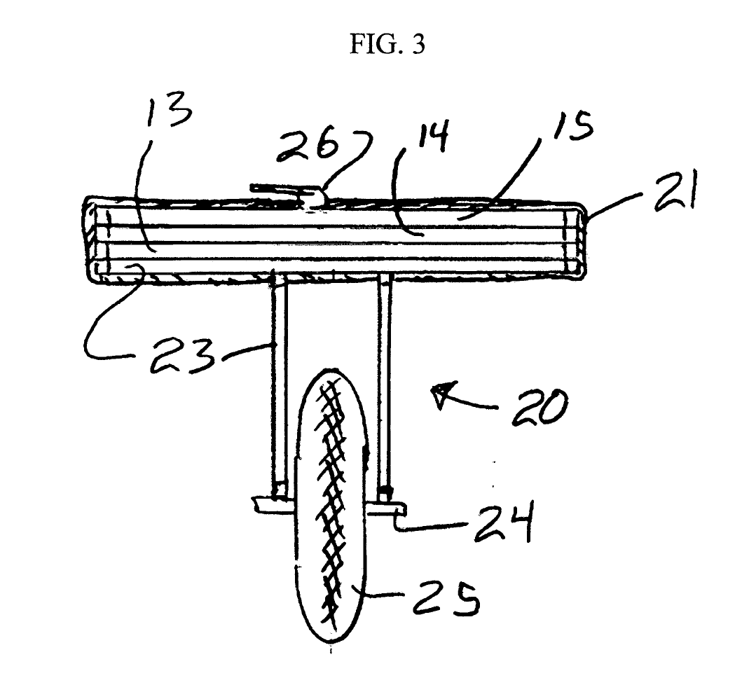

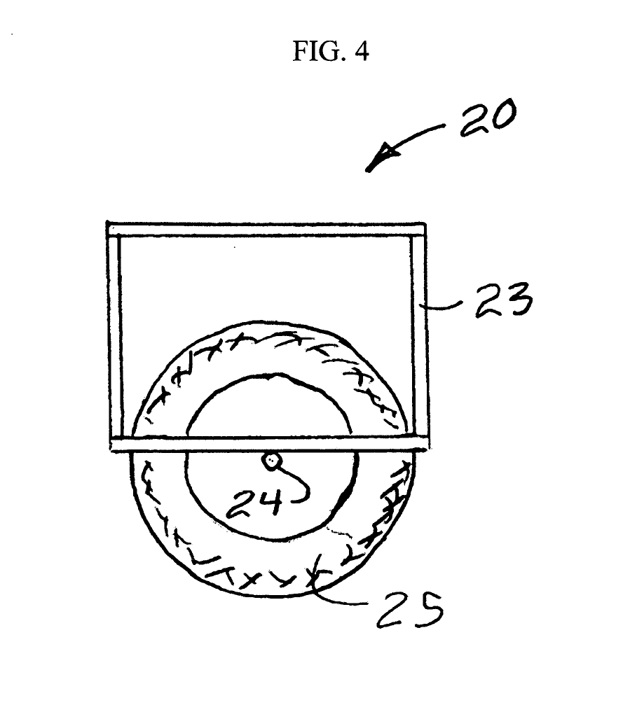

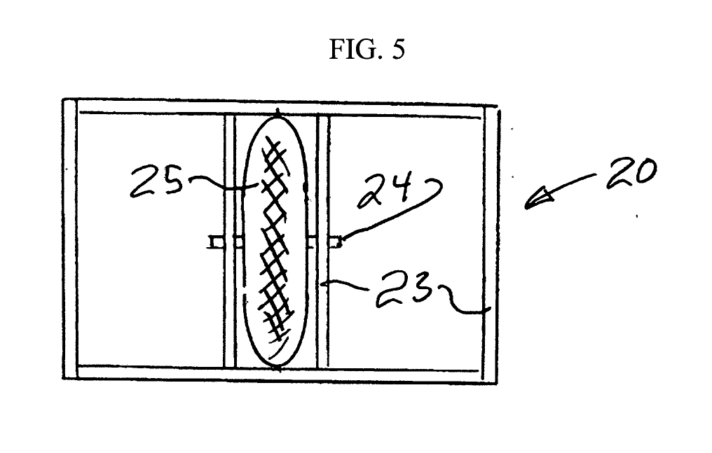

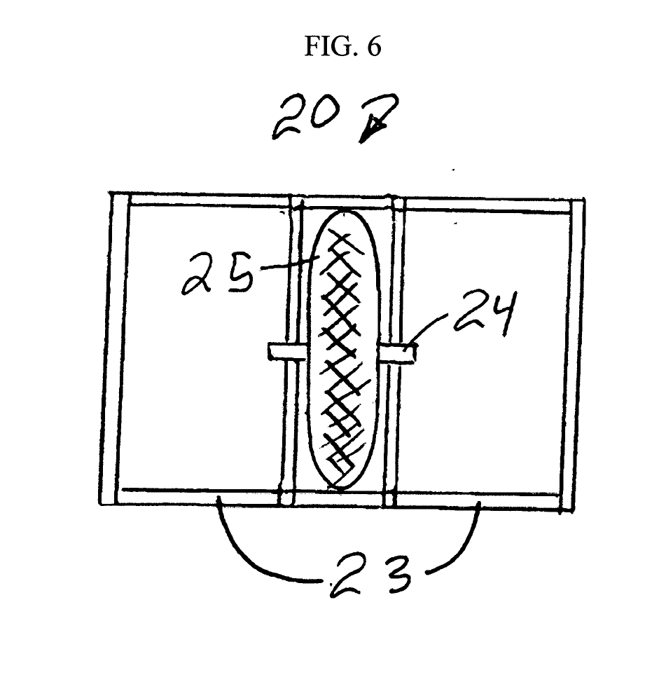

Referring now to FIG. 3, therein is shown a front view of the end of sections 13, 14 and 15, and ratchet strap 21 shown in FIG. 2. Apparatus 20 is comprised of frame 23, axle 24 and wheel 25. Ratchet strap 21 comprises ratchet assembly 26 for tightening ratchet strap 21 around sections 13, 14 and 15, and an upper portion of frame 23. Referring now to FIG. 4, therein is shown a side view of apparatus 20 of FIGS. 1-3 including frame 23, axle 24 and wheel 25. Referring now to FIG. 5, therein is shown a top view of apparatus 20 of FIGS. 1-3 including frame 23, axle 24 and wheel 25. Referring now to FIG. 6, therein is shown a bottom view of apparatus 20 of FIGS. 1-3 including frame 23, axle 24 and wheel 25.

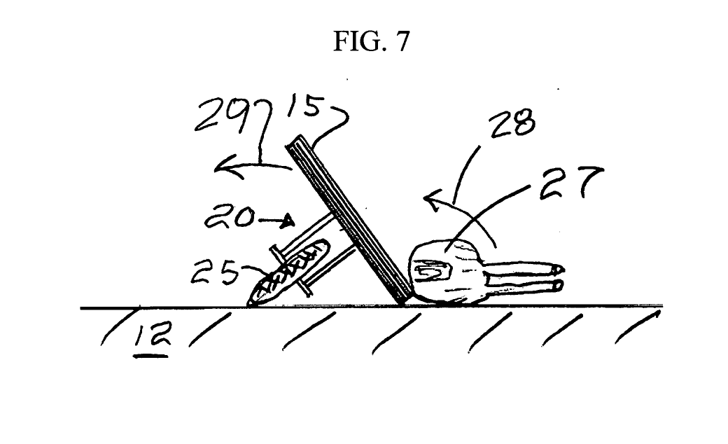

Referring again to FIGS. 2 and 3, it will be noticed that the width of the front of the sections 13, 14 and 15 is not increased by apparatus 20 thereby making the negotiation of a path through a wooded hunting location easier in comparison to prior art systems for transporting ladder tree stand sections using a pair of wheels positioned beside the rails of the ladder tree stand sections. In addition, it is easier to negotiate a tortious path with the single wheel of the instant invention because the assembly can be tipped into a turn. Referring now to FIG. 7, therein is depicted the loading of harvested big game animal 27 onto the assembly shown in FIG. 3, the assembly tipped onto ground 12 so that animal 27 can be rolled onto section 15 of the assembly in the manner depicted by arrow 28 so that the assembly can then be righted in the manner depicted by arrow 29 so that the harvested big game animal is above wheel 25 on section 15 so that animal 28 can be transported from a hunting location. The method depicted in FIG. 7 can be accomplished by one person and can be aided by the use of a ratchet strap for rolling animal 27 onto section 15. Placing a harvested big game animal onto a two wheeled assembly of the prior art is very difficult or impossible for a single person because a harvested big game animal can weigh more than a single person can lift. Although FIG. 7 depicts the assembly shown in FIG. 3 tipped on ground 12, it should be understood that apparatus 20 can be clamped to a single ladder tree stand section if desired so that, for example, the lower ladder tree stand section 15 can be used to transport animal 27 leaving ladder tree stand sections 13 and 14 in place on tree 11.

Frame 23 can be made out of any suitable material such as welded sections of steel or aluminum tubing. Frame 23 can be any suitable shape including the shape shown in above-referenced U.S. Provisional Patent Application Ser. No. 62/391,640. Wheel 25 can be any suitable type but preferably comprises a pneumatic tire having a diameter of about fourteen inches. Ratchet straps are readily available at hardware stores and home improvement stores. However, it should be understood that any suitable system can be used to clamp the apparatus of the instant invention to the ladder stand sections, such as the bolt and wing nuts or cam lock fasteners disclosed in above-referenced U.S. Provisional Patent Application Ser. No. 62/391,640.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains.

What is claimed is:

1. Apparatus for transporting sections of a ladder tree stand comprising: a frame, a single wheel, an axle and a clamp, the axle attached to the frame, the wheel mounted on the axle, the clamp for clamping the frame to a ladder tree stand section so that a hunter can transport the ladder tree stand section by pushing or pulling the stack of ladder tree stand section on the wheel of the frame.

2. The apparatus of claim 1, wherein the clamp is for clamping the frame to a stack of ladder tree stand sections.

3. The apparatus of claim 1, wherein the clamp comprises a ratchet strap.

4. The apparatus of claim 3, wherein the ratchet strap is for clamping the frame to a stack of ladder tree stand sections.

5. A method for transporting a section of a ladder tree stand, comprising:
(a) clamping the apparatus of claim 1 to a ladder tree stand section; and
(b) pushing or pulling the ladder tree stand section on the single wheel of the frame.

6. The method of claim 5, wherein the apparatus of claim 1 is clamped to a stack of ladder tree stand sections.

7. A method for transporting a harvested big game animal, comprising: (a) clamping the apparatus of claim 1 to a ladder tree stand section; (b) lying the ladder tree stand section on the ground beside a harvested big game animal so that the wheel is on the ground and the side of the ladder tree stand section is on the ground beside the harvested big game animal; (c) rolling the harvested big game animal onto the ladder tree stand section; (d) rotating the ladder tree stand section so that the harvested big game animal is above the wheel on the ladder tree stand section; and (c) pushing or pulling the ladder tree stand section on the single wheel of the frame to transport the harvested big game animal.

8. The method of claim 7, wherein the apparatus of claim 1 is clamped to a stack of ladder tree stand sections.
